(19) United States
(12) Patent Application Publication
(10) Pub. No.: US 2024/0120133 A1
(43) Pub. Date: Apr. 11, 2024

(54) Method for manufacturing an electric cable by extruding a composition based on a thermoplastic polymer, a dielectric liquid and uniformly distributed nanofillers

(71) Applicant: NEXANS, Courbevoie (FR)

(72) Inventors: Gabriele PEREGO, MILAN (IT); Christelle MAZEL, RUY (FR)

(21) Appl. No.: 18/203,052

(22) Filed: May 29, 2023

(30) Foreign Application Priority Data
May 31, 2022 (FR) 2205191

(51) Int. Cl. H01B 13/14

(52) U.S. Cl. CPC H01B 13/147; H01B 13/148

(57) ABSTRACT

A method for manufacturing an electric cable includes a step of mixing an extrusion composition having at least one thermoplastic polymer in the form of solid particles, a dielectric liquid and at least one nanofiller, a step of introducing the extrusion composition into a feed zone of a barrier screw which zone is situated at the inlet of the extruder, and a step of applying the extrusion composition coming from the prior step around an elongate electrically conducting element at the head of the extruder. The mixing step includes a step of premixing the dielectric liquid with the at least one nanofiller to obtain an intermediate composition which is then mixed with the at least one thermoplastic polymer in order to obtain the extrusion composition.

### RELATED APPLICATION

This application claims the benefit of priority from French Patent Application No. 22 05191, filed on May 31, 2022, the entirety of which is incorporated by reference.

### FIELD OF THE INVENTION

The present invention relates to a method for manufacturing an electric cable, notably of the power cable type, comprising an extruded thermoplastic layer obtained from a composition comprising a dielectric liquid, at least one thermoplastic polymer and at least one nanofiller.

The invention also relates to a cable obtained by said manufacturing method.

It typically, although not exclusively, applies to the electric cables intended to carry power, notably to medium-voltage (notably from 6 to 45-60 kV) or high-voltage (notably in excess of 60 kV, and perhaps ranging as high as 400 kV) power cables, whether carrying DC or AC current, in the fields of the overhead, underwater or overland transmission of electricity, or else in the field of aeronautics.

A medium-voltage or high-voltage power transmission cable generally comprises, from the inside to the outside:
an elongate electrically conducting element, notably made of copper or of aluminium;
an inner semiconductor layer surrounding said elongate electrically conducting element;
an electrically insulating layer surrounding said inner semiconductor layer;
an outer semiconductor layer surrounding said insulating layer; and
possibly an electrically insulating protective sheath surrounding said outer semiconductor layer.

### TECHNICAL BACKGROUND

It is known that a uniform distribution of nanofillers or, in other words, a nanometric-scale filler, making it possible to obtain an electrically insulating layer for an electric cable makes it possible to obtain a higher resistivity per unit volume and to reduce the space-charge accumulation phenomenon. In addition, the uniformly distributed nanofillers may increase the AC and DC dielectric strength of the insulating compounds.

During the manufacture of the insulating layer, the thermoplastic polymer in the form of solid particles, the dielectric liquid and the nanofillers are mixed together and then introduced into an extruder in order to apply the insulating layer to an electrical conductor.

A method for manufacturing such a layer in which the thermoplastic polymer granules are impregnated with the dielectric liquid and then mixed with the nanofillers before the composition obtained is introduced into the extruder is notably known from document WO2018234697 A1.

It was found that the particles of nanofillers may agglomerate and form particles of larger size within the composition. Now, the presence of large-sized inorganic nanofiller particles has effects that are far more harmful than the beneficial effects obtained by the incorporation of nanofillers distributed uniformly.

Specifically, the large-sized particles lead to a local change in the electric field and a degraded potential interface between the inorganic particle and the polymer matrix.

The nanocomposites lead to an improvement in the electrical properties because the electric field is modulated by the nanoparticles. In particular, in a high-voltage direct current (HVDC) application, the nanocomposites benefit from weaker space charge phenomena and higher resistivity per unit volume.

However, it is important to exclude the presence of large agglomerations of particles because these would act like large inorganic particles and excessively locally deflect the electric field and lead to phenomena of electrical degradation at the interface.

There is therefore a need for a method for manufacturing an insulating layer that allows the nanofillers to be distributed uniformly in the insulating layer so as to obtain greater AC and DC dielectric strength, higher resistivity per unit volume and a greater reduction in the space charge accumulation phenomenon than are achieved with an insulating layer that does not contain nanofillers.

### Objects and Summary

In order to do that, the invention proposes a method for manufacturing an electric cable comprising at least one elongate electrically conducting element and at least one extruded thermoplastic layer surrounding said elongate electrically conducting element, said method implementing a device comprising at least one extruder containing a barrel, a barrier screw and an extrusion head, characterized in that it comprises at least the following steps:
i) a step of mixing an extrusion composition comprising at least one thermoplastic polymer in the form of solid particles, a dielectric liquid and at least one nanofiller, ii) a step of introducing said extrusion composition into a feed zone of the barrier screw which zone is situated at the inlet of the extruder, and
iii) a step of applying the extrusion composition coming from step ii) around the elongate electrically conducting element at the head of the extruder, said method being characterized in that the mixing step i) comprises a step of premixing the dielectric liquid with said at least one nanofiller to obtain an intermediate composition which is then mixed with said at least one thermoplastic polymer in order to obtain the extrusion composition.

Premixing the nanofillers in the dielectric liquid makes it possible to ensure a uniform distribution of the nanofillers in the dielectric liquid and this then makes it possible to obtain a uniform distribution of the nanofillers in the extrusion composition. Premixing allows each of the nanofillers to be surrounded by a layer of dielectric liquid and thus be separated from the rest of the nanofillers in order to reduce agglomeration The insulating layer extruded by means of the extruder thus has a higher AC and DC dielectric strength, a greater resistivity per unit volume and a greater reduction in the space charge accumulation phenomenon than are obtained for an insulating layer without nanofillers.

Premixing the nanofillers with the dielectric liquid also means that an optional step of filtering the intermediate composition can be performed so as to reduce the level of impurities in the composition. This filtration step is possible because the low viscosity of the dielectric liquid allows fine filtration. By contrast, a polymer mixture has a higher viscosity which means that such filtration cannot be performed unless the pressure of this composition is increased significantly.

Such premixing is specific to the use of thermoplastic polymers. Specifically, if a layer based on crosslinked polyethylene were used, such premixing would cause poor crosslinking because it would promote reactions between the free radicals and the peroxide bonds.

According to one embodiment of the manufacturing method, said at least one nanofiller has at least one maximum dimension less than or equal to 1000 nm.

According to one embodiment of the manufacturing method, said at least one nanofiller is a mineral filler, preferably selected from the carbonates of alkaline earth metals, the sulfates of alkaline earth metals, metal oxides, metalloid oxides, metal silicates and siloxanes.

According to one embodiment of the manufacturing method, the dielectric liquid is an oil.

According to one embodiment of the manufacturing method, said oil is a mineral oil.

According to one embodiment of the manufacturing method, said at least one thermoplastic polymer is selected from a propylene homopolymer and a propylene copolymer.

According to one embodiment of the manufacturing method, the propylene copolymer is a heterophasic propylene copolymer, a statistical propylene copolymer or a mixture thereof.

According to one embodiment of the manufacturing method, the extrusion composition further comprises a polyethylene in solid form.

According to one embodiment of the manufacturing method, the pressure during step ii) is at most 5 bar, preferably at most 3 bar, and preferably at most 1.5 bar.

According to one embodiment of the manufacturing method, the premixing step is performed by a mixer distinct from the extruder.

According to one embodiment of the manufacturing method, the mixer is a turbo-mixer or a closed mixer.

According to one embodiment of the manufacturing method, the mixing step further comprises a step of filtering the intermediate composition in order to filter out any impurities present in the intermediate composition.

Specifically, it is simpler and more effective to filter out any impurities present in the powder-form nanofillers when these fillers have been incorporated into a liquid, in this instance the dielectric liquid.

The invention also proposes an electric cable comprising at least one elongate electrically conducting element and at least one extruded thermoplastic layer surrounding said elongate electrically conducting element, characterized in that it is obtained according to a method of manufacture as defined hereinabove.

### BRIEF DESCRIPTION OF THE DRAWINGS

The description which will follow, with reference to the attached drawings which are given by way of nonlimiting examples, will make it easy to understand what the invention consists in and how it may be carried out. In the attached figures:

FIG. 1 schematically depicts a partially sectioned view of an extruder notably comprising an extrusion screw and a barrel.

FIG. 2 schematically depicts a partially sectioned and perspective view of an electric cable obtained using the extruder of FIG. 1.

### DETAILED DESCRIPTION

For the sake of clarity, only the elements essential to the understanding of the invention have been depicted schematically in these figures, and without being drawn to scale.

The concept of the invention is described more completely hereinafter with reference to the attached drawings, in which embodiments of the concept of the invention are shown. In the drawings, the size and relative scale of the elements may be exaggerated for the sake of clarity. Similar numerals refer to similar elements across all the drawings. However, this concept of the invention may be implemented in numerous different forms and should not be interpreted as being limited to the embodiments set forth here. Rather, these embodiments are offered so that this description is complete, and communicate the extent of the concept of the invention to those skilled in the art.

Throughout the specification, a reference to “an embodiment” means that a functionality, a structure or a particular feature described in connection with one embodiment is included in at least one embodiment of the present invention. Thus, where the expression “in one embodiment” appears at various points throughout the specification, this does not necessarily refer to the one same embodiment. Further, the functionalities, structures or particular features may be combined in any appropriate way in one or more embodiments. Additionally, the term “comprising” does not exclude there being other elements or steps.

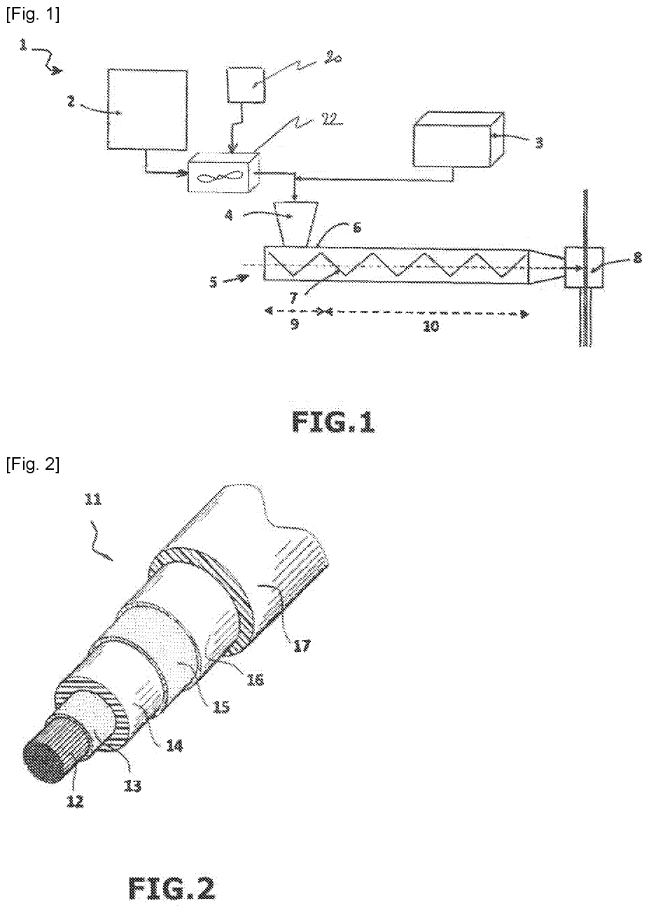

In FIG. 1, an installation 1 for manufacturing an insulating layer of an electric cable comprises a first container 2 fed with a dielectric liquid, a second container 20 fed with nanofillers and a third container 3 fed with a thermoplastic polymer.

The thermoplastic polymer, the dielectric liquid and the nanofillers are intended to be mixed in order to obtain an extrusion composition to be introduced into an extruder 5. The device 1 may also comprise a feed hopper 4 that may be fed with the extrusion composition.

The nanofillers and the dielectric liquid are premixed in a mixer 22 to obtain an intermediate composition. The mixer 22 is preferably a turbomixer or a closed mixer. The mixer 22 is preferably distinct from the extruder 5. The mixer 22 notably comprises a receiving cavity in which a blade mixer or turbine allows high-speed mixing. The blade mixer or the turbine may comprise a plurality of blades with different orientations in order to encourage agitation of the intermediate composition.

The intermediate composition comprising the dielectric liquid and the nanofillers is then mixed with the thermoplastic polymer prior to or at the same time as these are introduced into the extruder 5. This mixing of the intermediate composition and of the thermoplastic polymer may be performed in the feed hopper 4 or inside the extruder 5.

The nanofillers and the dielectric liquid are therefore mixed together before being mixed with the thermoplastic polymer.

Premixing the nanofillers into the dielectric liquid makes it possible to ensure uniform distribution of the nanofillers in the dielectric liquid, and this then makes it possible to obtain uniform distribution of the nanofillers in the extrusion composition. The insulating layer extruded by means of the extruder 5 thus has higher AC and DC dielectric strength, higher resistivity per unit volume and a greater reduction in the space charge accumulation phenomenon than are obtained for an insulating layer without nanofillers.

The thermoplastic polymer preferably takes the form of solid particles, referred to as pellets or granules. The thermoplastic polymer is preferably a propylene-based thermoplastic such as a propylene homopolymer or a propylene copolymer. The propylene copolymer may be a heterophasic propylene copolymer, a statistical propylene copolymer or a mixture of these.

The choice of the dielectric liquid depends on the envisaged application (i.e. on the type of electrical equipment) and on its compatibility with the solid insulator that it is supposed to impregnate and/or with which it forms an intimate mixture. Among conventional dielectric liquids, mention may be made of mineral oils (e.g. naphthenic oils, paraffin oils, aromatic oils, or polyaromatic oils), vegetable oils (e.g. soya oil, linseed oil, rapeseed oil, corn oil or castor oil) or synthetic oils such as aromatic hydrocarbons (alkylbenzenes, alkylnaphthalenes, alkylbiphenyls, alkydiarylethylenes, etc.), silicone oils, ether-oxides, organic esters or aliphatic hydrocarbons.

The nanofillers may take the form of powder. The nanofillers for example comprise at least one mineral filler, preferably selected from among the carbonates of alkaline earth metals, the sulfates of alkaline earth metals, metal oxides, metalloid oxides, metal silicates, and siloxanes. Several types of nanofiller may be used in the intermediate composition.

The nanofillers preferably have a maximum dimension less than or equal to 1000 nm.

The extruder 5 comprises for example a barrel 6 and a barrier screw 7, as well as an extruder head 8. The extruder 5 may be a twin-screw extruder, an extruder of the Buss extruder type, or a single-screw extruder.

The extrusion composition is introduced into a feed zone 9 of the screw 7 and progresses towards one or more intermediate zones 10 where the thermoplastic polymer gradually melts, said intermediate zones 10 being situated between the feed zone 9 and the extrusion head 8.

Finally, at the extrusion head 8, the composition is applied around an elongate electrically conducting element.

In FIG. 2, the medium-voltage or high-voltage power cable 11 obtained according to the method of the invention comprises a central elongate electrically conducting element 12, notably made of copper or of aluminium, and, successively and coaxially, comprises around this element 12, a first semiconductor layer 13 referred to as “inner semiconductor layer”, an electrically insulating layer 14, a second semiconductor layer 15 referred to as “outer semiconductor layer”, a metal screen 16 of the cylindrical tube type, and a protective outer sheath 17, the electrically insulating layer 14 being obtained from a composition comprising at least one thermoplastic polymer selected from among a propylene homopolymer and a propylene copolymer, and a dielectric liquid according to an extrusion method as defined in the invention.

The layers 13 and 15 are layers that are extruded using methods well known to those skilled in the art. The presence of the metal screen 16 and of the protective outer sheath 17 is preferable, but not essential.

1. A method for manufacturing an electric cable comprising at least one elongate electrically conducting element and at least one extruded thermoplastic layer surrounding said elongate electrically conducting element, said method implementing a device comprising at least one extruder containing a barrel, a barrier screw and an extrusion head, wherein said method comprises at least the following steps:
i) a step of mixing an extrusion composition comprising at least one thermoplastic polymer in the form of solid particles, a dielectric liquid and at least one nanofiller,
ii) a step of introducing said extrusion composition into a feed zone of the barrier screw which zone is situated at the inlet of the extruder, and
iii) a step of applying the extrusion composition coming from step ii) around the elongate electrically conducting element at the head of the extruder,
wherein the mixing step i) comprises a step of premixing the dielectric liquid with said at least one nanofiller to obtain an intermediate composition which is then mixed with said at least one thermoplastic polymer in order to obtain the extrusion composition.

2. The method according to claim 1, wherein said at least one nanofiller has at least one maximum dimension less than or equal to 1000 nm.

3. The method according to claim 1, wherein said at least one nanofiller is a mineral filler, preferably selected from the carbonates of alkaline earth metals, the sulfates of alkaline earth metals, metal oxides, metalloid oxides, metal silicates and siloxanes.

4. The method according to claim 1, wherein the dielectric liquid is an oil.

5. The method according to claim 4, wherein said oil is a mineral oil.

6. The method according to claim 1, wherein said at least one thermoplastic polymer is selected from a propylene homopolymer and a propylene copolymer.

7. The method according to claim 6, wherein the propylene copolymer is a heterophasic propylene copolymer, a statistical propylene copolymer or a mixture thereof.

8. The method according to claim 1, wherein the extrusion composition further comprises a polyethylene in solid form.

9. The method according to claim 1, wherein the pressure during step ii) is at most 5 bar.

10. The method according to claim 1, wherein the premixing step is performed by a mixer distinct from the extruder.

11. The method according to claim 10, wherein the mixer is a turbo-mixer or a closed mixer.

12. The method according to claim 1, wherein the mixing step further comprises a step of filtering the intermediate composition in order to filter out any impurities present in the intermediate composition.

13. An electric cable comprising at least one elongate electrically conducting element and at least one extruded thermoplastic layer surrounding said elongate electrically conducting element, wherein said electric cable is obtained according to a method of manufacture as defined in claim 1.

14. The method according to claim 9, wherein the pressure during step ii) is at most 3 bar.

15. The method according to claim 14, wherein the pressure during step ii) is at most 1.5 bar.
